(19) United States
(12) Patent Application Publication
(10) Pub. No.: US 2025/0053433 A1
(43) Pub. Date: Feb. 13, 2025

(54) CAPABILITY ORCHESTRATION IN A CLOUD-NATIVE ENVIRONMENT

(71) Applicant: International Business Machines Corporation, Armonk, NY (US)

(72) Inventors: Guangya Liu, Cary, NC (US); Hou Fang Zhao, Beijing (CN); Jian Huang, Beijing (CN); Ying Mo, Beijing (CN); Xiaoli Duan, Beijing (CN); Yan Wei Li, Beijing (CN); Zhi Li, Beijing (CN)

(21) Appl. No.: 18/366,114

(22) Filed: Aug. 7, 2023

(51) Int. Cl. G06F 9/455

(52) U.S. Cl. CPC G06F 9/45558; G06F 2009/4557

(57) ABSTRACT

Capability orchestration in a cloud-native environment includes one or more new combined capability definitions generated by one or more processing units based on existing capability definitions and a combined capability manifest to form a hierarchy of capability definitions. A capability request directed to one or more capabilities can be received by the one or more processing units. One or more capability definitions corresponding to the one or more capabilities can be determined from the hierarchy of capability definitions by the one or more processing units based on the capability request. Deployable resources can be derived by the one or more processing units based on the determined one or more capability definitions. The one or more capabilities can be generated by the one or more processing units based on the derived deployable resources.

### BACKGROUND

The present disclosure relates to capability orchestration, and more specifically, to a computer-implemented method, a system, and a computer program product for capability orchestration in a cloud-native environment.

Cloud-native technologies empower organizations to build and run scalable applications in modern, dynamic environments such as public, private, and hybrid clouds. Cloud-native refers to containerized applications or software including an application development mode with cloud architecture as the priority. Currently, an increasingly large number of developers are adopting cloud-native technologies to develop applications. There are many platforms or environments for cloud-native development and service, such as Kubernetes™ or termed as K8s.

### SUMMARY

According to one embodiment of the present disclosure, there is provided a computer-implemented method for capability orchestration in a cloud-native environment. In this method, one or more new combined capability definitions can be generated by one or more processing units based on existing capability definitions and a combined capability manifest to form a hierarchy of capability definitions which include the one or more new combined capability definitions and the existing capability definitions. A capability request directed to one or more capabilities can be received by one or more processing units. The one or more capabilities can correspond to one or more capability definitions in the hierarchy of capability definitions. The one or more capability definitions corresponding to the one or more capabilities can be determined from the hierarchy of capability definitions by one or more processing units based on the capability request. Deployable resources can be derived by one or more processing units based on the determined one or more capability definitions. The one or more capabilities can be generated by one or more processing units based on the derived deployable resources.

According to another embodiment of the present disclosure, there is provided a system for capability orchestration in a cloud-native environment. The system can include one or more processors, a memory coupled to at least one of the processors and a set of computer program instructions stored in the memory. When executed by at least one of the processors, the set of computer program instructions can perform following actions. One or more new combined capability definitions can be generated based on existing capability definitions and a combined capability manifest to form a hierarchy of capability definitions, which include the one or more new combined capability definitions and the existing capability definitions. A capability request directed to one or more capabilities can be received. The one or more capabilities can correspond to one or more capability definitions in the hierarchy of capability definitions. The one or more capability definitions corresponding to the one or more capabilities can be determined from the hierarchy of capability definitions based on the capability request. Deployable resources can be derived based on the determined one or more capability definitions. The one or more capabilities can be generated based on the derived deployable resources.

According to a yet another embodiment of the present disclosure, there is provided a computer program product for capability orchestration in a cloud-native environment. The computer program product can include a computer readable storage medium having program instructions embodied therewith. The program instructions are executable by a processor to cause the processor to perform following actions. One or more new combined capability definitions can be generated based on existing capability definitions and a combined capability manifest to form a hierarchy of capability definitions, which include the one or more new combined capability definitions and the existing capability definitions. A capability request directed to one or more capabilities can be received. The one or more capabilities can correspond to one or more capability definitions in the hierarchy of capability definitions. The one or more capability definitions corresponding to the one or more capabilities can be determined from the hierarchy of capability definitions based on the capability request. Deployable resources can be derived based on the determined one or more capability definitions. The one or more capabilities can be generated based on the derived deployable resources.

### BRIEF DESCRIPTION OF THE DRAWINGS

Through the more detailed description of some embodiments of the present disclosure in the accompanying drawings, the above and other objects, features, and advantages of the present disclosure will become more apparent, wherein the same reference generally refers to the same components in the embodiments of the present disclosure.

FIG. 1 shows an exemplary computing environment which is applicable to implement the embodiments of the present disclosure;

FIG. 2 shows a schematic diagram of a scenario to which an embodiment of the present disclosure is applied;

FIG. 3 shows an example of a hierarchy of capability definitions, according to an embodiment of the present disclosure;

FIG. 4 shows a flowchart of a method for capability orchestration in a cloud-native environment, according to an embodiment of the present disclosure;

FIG. 5 shows an example of two primary capability definitions, according to an embodiment of the present disclosure;

FIG. 6 shows an example of a combined capability manifest, according to an embodiment of the present disclosure;

FIG. 7 shows examples of two capability requests, according to an embodiment of the present disclosure; and

FIG. 8 shows a system for capability orchestration in a cloud-native environment, according to an embodiment of the present disclosure.

The drawings are not necessarily to scale. The drawings are merely schematic representations, not intended to portray specific parameters of the invention. The drawings are intended to depict only typical embodiments of the invention. In the drawings, like numbering represents like elements.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as capability orchestration code 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

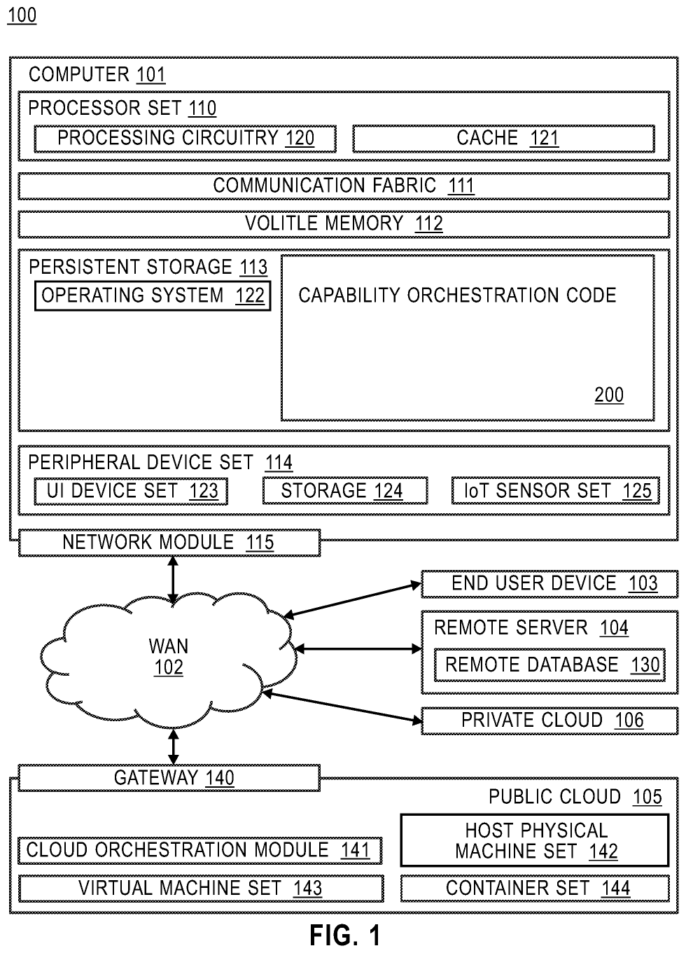

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network, or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a user of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

It is understood that the computing environment 100 in FIG. 1 is only provided for illustration purpose without suggesting any limitation to any embodiment of this disclosure, for example, at least part of the program code involved in performing the inventive methods could be loaded in cache 121, volatile memory 112 or stored in other storage (e.g., storage 124) of the computer 101, or at least part of the program code involved in performing the inventive methods could be stored in other local or/and remote computing environment and be loaded when need. For another example, the peripheral device set 114 could also be implemented by an independent peripheral device connected to the computer 101 through interface. For a further example, the WAN may be replaced and/or supplemented by any other connection made to an external computer (for example, through the Internet using an Internet Service Provider).

An application, or termed as software or product, can be built based on a set of capabilities, and a capability represents a set of functionalities provided by the application to meet a user's specific requirement. Based on actual needs of users, instead of taking a whole cloud native application or a couple of applications to build a complete solution, which is usually very complicated, expensive, and resource intensive, more and more users tend to adopt those applications by selecting one or more of capabilities provided by those applications based on use cases, and then customizing or orchestrating the capabilities to build a custom-oriented solution.

In order to customize capabilities from a single application, or orchestrate capabilities from multiple applications, usually it requires considerable development effort for the single application to allow customization and ad hoc resolution across the multiple applications to allow orchestration.

Embodiments of the present disclosure aim to solve at least one of the technical problems described above, and propose a method, a system and a computer program product for capability orchestration in a cloud native environment, which can establish hierarchical capability definitions to manage a large number of capabilities from one or more existing cloud native applications, provide one or more capabilities automatically based on a user's requirement and the large number of capabilities from one or more existing cloud native applications, and require much less development effort.

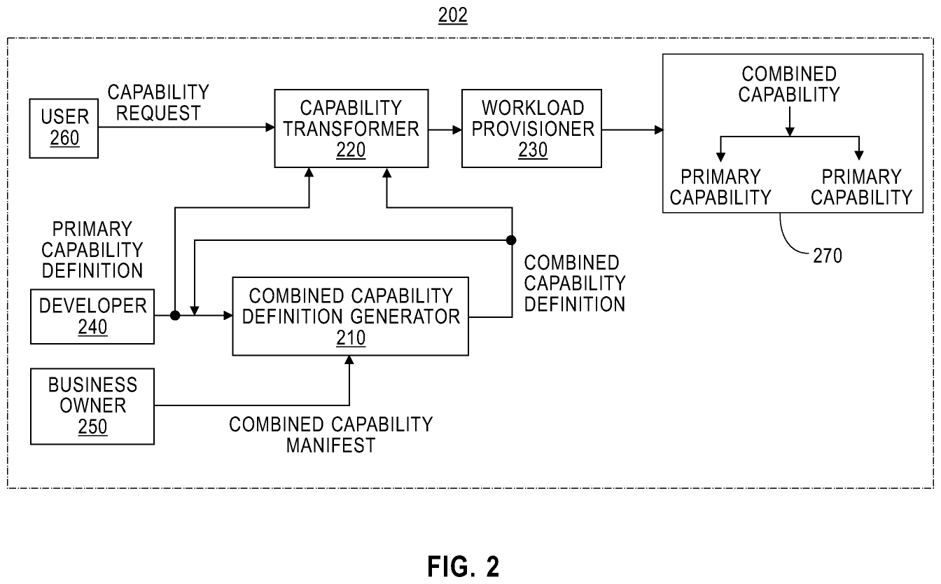

With reference now to FIG. 2, a schematic diagram 202 of functional components of the capability orchestration code 200 is shown, according to an embodiment of the present disclosure. As can be seen in FIG. 2, the depicted embodiment introduces a combined capability definition generator 210 and a capability transformer 220, to work with an existing workload provisioner 230 in the cloud-native environment, so as to solve at least one of the technical problems described above. The workload provisioner 230 can be one of an existing method or module in the cloud-native environment to support cloud-native application deployment. Both of the combined capability definition generator 210 and the capability transformer 220 can be implemented by one or more processing units. It should be understood that although the combined capability definition generator 210 and the capability transformer 220 are shown as separate modules or units, they can be implemented in one single module or unit, which can implement functions of the two modules or units.

As stated above, an application can be built based on a set of capabilities, which can be introduced as primary capabilities herein. A primary capability is one capability that cannot be further divided into other capabilities but can be combined to form other capabilities. Each primary capability may have a corresponding primary capability definition, which can be written by, for example, a developer 240 who develops the primary capability. The primary capability definition can be written in any markup language in a cloud native environment such as K8s. For example, the primary capability definition can be written in YAML (Yet Another Markup Language) or JSON (JavaScript Object Notation) in K8s. The primary capability definition can include basic information on the primary capability, such as a capability name, a capability version, etc. More importantly, the primary capability definition can define a set of deployable resources for the primary capability, which can be used by the workload provisioner 230 in the cloudnative environment to ultimately generate one or more capabilities for a user.

As stated above, a more frequent way for a user to adopt an application or applications is to select one or more of primary capabilities provided by the application(s) based on use cases, and then customize or orchestrate the selected primary capabilities to build a custom-oriented solution (application). However, the customization and orchestration require considerable development effort. In other words, combined capabilities need to be generated based on primary capabilities and managed to form a custom-oriented application, which requires considerable development effort, because each combination of the capabilities will require extra development effort to produce a managing operator in the cloud-native environment for managing the generated combined capability 270. A combined capability mentioned herein can be a capability that is built by combining other capabilities. The capabilities to be combined can be primary capabilities, existing combined capabilities, or both primary capabilities and existing combined capabilities.

The present embodiment introduces the combined capability definition generator 210 and the capability transformer 220 to work together with the workload provisioner 230 to solve at least one of the technical problems described above. Specifically, instead of combining capabilities and managing combined capabilities on a capability basis based on a user's requirement, a concept of combined capability definition is established. After primary capabilities and corresponding primary capability definitions are defined by developer(s) 240, business owner(s) 250 can instruct, through a combined capability manifest, which capabilities can be combined and how they can be combined, so that combinations of capabilities are meaningful to users from a business perspective. To be meaningful to users from a business perspective means that not all combinations of existing capabilities can be generated, but only the ones that are valid and useful to a user from the business perspective or have a potential to be adopted by a user can be generated. Through excluding combinations that are not meaningful to users via the combined capability manifest, storage resources can be saved and usefulness of ultimately generated capabilities can be increased. The combined capability definition generator 210 can generate one or more combined capability definitions based on existing capability definitions and the combined capability manifest. Each of the generated combined capability definitions is corresponding to a combined capability. It can be understood and seen from FIG. 2 that the generated combined capability definitions can be further used by the combined capability definition generator 210 to generate other combined capability definitions. Therefore, the capabilities to be combined, which correspond to respective capability definitions inputted to the combined capability definition generator 210, can include primary capabilities, existing combined capabilities, or both primary capabilities and existing combined capabilities. Through the combined capability definition generator 210, a hierarchy of capability definitions can be formed. Similarly, as stated above for the primary capability definition, each capability definition in the hierarchy of capability definitions, either a primary capability definition or a combined capability definition, can include information regarding the corresponding primary capability or combined capability, such as a capability name, a capability version, and a set of deployable resources for the corresponding capability.

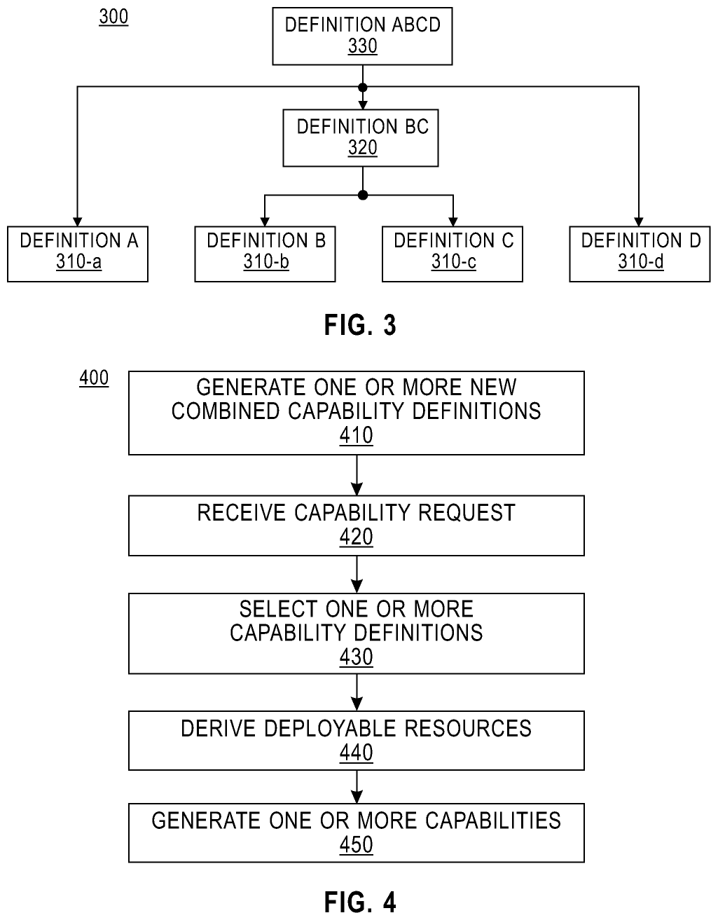

With reference now to FIG. 3, it is shown an example of a hierarchy 300 of capability definitions formed by the combined capability definition generator 210 according to an embodiment of the present disclosure. As shown in FIG. 3, there are 4 primary capability definitions 310, namely definition A 310-a, definition B 310-b, definition C 310-c, and definition D 310-d, corresponding to primary capabilities A, B, C and D, respectively. The combined capability definition generator 210 may firstly generate a combined capability definition, that is, definition BC 320, which corresponds to a combined capability BC (a combination of primary capabilities B and C), based on the primary capability definitions 310 and the combined capability manifest. The combined capability definition generator 210 may further generate another combined capability definition, that is, definition ABCD 330, which corresponds to a combined capability ABCD (a combination of primary capabilities A and D and combined capability BC), based on the primary capability definitions (i.e., primary capability definitions A and D) and the combined capability definition (i.e., the combined capability definition BC) as well as the combined capability manifest. Therefore, a hierarchy 300 of three (3) levels of capability definitions formed by the combined capability definition generator 210. It should be understood that a hierarchy of 3 levels is shown in FIG. 3 for case of description, however, a hierarchy of more or less levels than the 3 levels shown in FIG. 3 can be formed, for example, a hierarchy of 2 levels or 5 levels can be formed.

Referring back to FIG. 2, the present embodiment also introduces the capability transformer 220, which can be used to transform a capability request from a user 260 directed to one or more capabilities, either primary or combined, into information that can be recognized by the workload provisioner 230 existing in the cloud-native environment based on the formed hierarchy of capability definitions. Specifically, the information that can be recognized by the workload provisioner 230 can be deployable resources mentioned above which can be used by the workload provisioner 230 to ultimately generate the one or more capabilities requested by the user 260 through the capability request. The generated one or more capabilities can include one or more primary capabilities and/or one or more combined capabilities.

The workload provisioner 230 mentioned herein may refer to any existing provisioning method or module in the cloud-native environment that supports cloud native application deployment and using deployable resources to generate one or more corresponding capabilities. Examples of the workload provisioner 230 can include, but are not limited to, OLM (Operator Lifecycle Manager), ODLM (Operand Deployment Lifecycle Manager), HELM which is an open source K8s package manager, Terraform™ which is a deployment tool for IaC (Infrastructure as Code) and Ansible™ which is a configuration management tool for IaC.

Through the combined capability definition generator 210, combinations of different capabilities can be mapped to corresponding combined capability definitions, and the hierarchy of capability definitions can be generated automatically. Therefore, through the combined capability definition generator 210, there is no need for extra development effort or writing additional codes to orchestrate or manage combined capabilities, as only combined capability definitions need to be managed. The capability definitions are written in markup languages, which are much easier to manage. Through the capability transformer 220, a user's request for a combination of one or more capabilities from the same cloud-native application or different cloud-native applications can be transformed to information that can be understood by existing modules such as the workload provisioner 230 in the cloud-native environment, and therefore capabilities requested by the user can be generated automatically and there is no need to modify existing structures in the cloud-native environment, making the solution of the present disclosure easy to implement.

With reference now to FIG. 4, a flowchart of a method 400 for capability orchestration in a cloud-native environment is shown, according to an embodiment of the present disclosure. Method 400 can be implemented by the combined capability definition generator 210, the capability transformer 220 and the workload provisioner 230 in FIG. 2 and, for example, in the computing environment of FIG. 1.

At step 410, one or more new combined capability definitions can be generated based on existing capability definitions and a combined capability manifest. There are various ways for obtaining the existing capability definitions in the cloud native environment. For example, if the capability definitions are written in YAML as described above, a command line program can be used to identify a YAML document corresponding to a capability definition based on for example a header of the YAML document. The generated one or more new combined capability definitions together with the existing capability definitions can form a hierarchy of capability definitions, such as the exemplary hierarchy of capability definitions shown in FIG. 3. Step 410 can be performed by the combined capability definition generator 210 in FIG. 2.

In some embodiments, the existing capability definitions may include one or more primary capability definitions and/or one or more existing combined capability definitions. As stated above, each of the primary capability definitions may correspond to a primary capability. The primary capability definition for each primary capability has already been written by a developer who develops the primary capability. Similar to the primary capability definition, each of the combined capability definitions, either a generated new combined capability definition or an existing combined capability definition, can correspond to a combined capability. The combined capability herein can be one capability that is a combination of two or more capabilities, and the capabilities to be combined can be primary capabilities and/or existing combined capabilities.

In some embodiments, primary capabilities corresponding to the primary capability definitions may be from a same cloud-native application or different cloud-native applications, so that capabilities management at different levels from customizing capabilities for a single cloud-native application to orchestrating capabilities across multiple cloud-native applications can be achieved based on user's requirement.

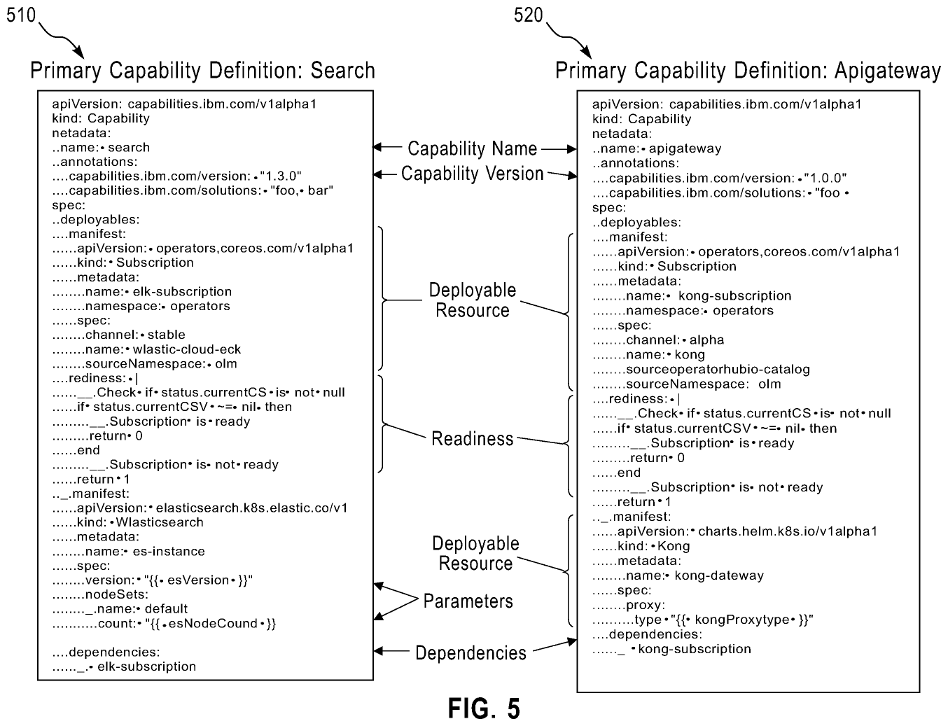

With reference now to FIG. 5, an example of two primary capability definitions 510, 520 with the name of “search” (510) and “apigateway” (520), respectively are shown, according to an embodiment of the present disclosure. As shown in FIG. 5, each of the primary capability definitions 510, 520 can define basic information for a corresponding primary capability, such as a capability name and a capability version. Also, each primary capability definition 510, 520 can define a set of deployable resources for a corresponding primary capability. The set of deployable resources may include one or more deployable resources. Taking the primary capability definition “apigateway” 520 shown in FIG. 5 as an example, it has a set of deployable resources with the name of “kong-subscription” and “kong-gateway” respectively. The set of deployable resources for the primary capability can be used by the workload provisioner 230 in the cloud-native environment as described above to generate one or more capabilities for a user. For example, in the cloud-native environment such as K8s, the deployable resources can refer to CRs (custom resources).

In some embodiments, some of the deployable resources for a primary capability may have dependencies. Still taking the primary capability definition “apigateway” 520 shown in FIG. 5 as an example, it can be seen that the deployable resource with a name of “kong-gateway” has a dependency on the deployable resource with a name of “kong-subscription”. That is to say, from the perspective of the workload provisioner 230, in order to generate the primary capability “apigateway” 520, two deployable resources “kong-subscription” and “kong-gateway” are needed, and the deployable resource “kong-subscription” has to be already received and ready before the receiving of the deployable resource “kong-gateway”. Whether a deployable resource is ready can be determined or checked through information such as readiness of the deployable resource. Therefore, readiness of one or more deployable resources in the set of deployable resources and dependencies between two or more deployable resources in the set of deployable resources can also be defined in the primary capability definition.

In some embodiments, as further shown in FIG. 5, the primary capabilities definition each may further define one or more parameters to be customized, so that a user can customize the parameters and therefore customize capabilities as needed by inputting one or more values for instantiation of the one or more parameters.

As each of the combined capability definitions in the hierarchy of capability definitions is generated based on a combination of primary capability definitions, it can be understood that, similar to the primary capability definition, each combined capability definition in the hierarchy of capability definitions can define a set of deployable resources for a corresponding combined capability, together with readiness of one or more deployable resources in the set of deployable resources and dependencies between two or more deployable resources in the set of deployable resources. Further, each combined capability definition in the hierarchy of capability definitions can also define one or more parameters to be customized, similar as the primary capability definition.

In some embodiments, each primary capability definition 510, 520, which is written by a developer of a corresponding primary capability, can be written in a markup language, such as YAML and JSON mentioned above. Since each combined capability definition is generated based on primary capability definitions, it can be understood that each combined capability definition can be written in the same markup language as the primary capability definition. Therefore, each capability definition in the hierarchy of capability definitions, either a primary capability definition or a combined capability definition, can be written in a markup language, such as YAML and JSON mentioned above.

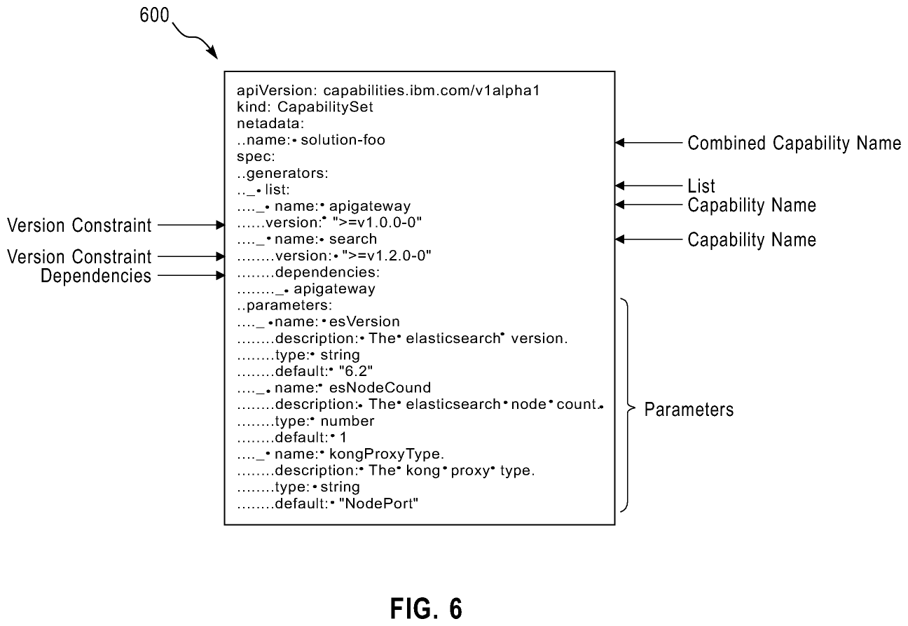

With reference now to FIG. 6, it is shown an example of a combined capability manifest 600 according to an embodiment of the present disclosure. As stated above, business owners can instruct, through the combined capability manifest, which capabilities can be combined and how they can be combined, so that combinations of capabilities are meaningful to users from a business perspective. Being meaningful to users from a business perspective means that not all combinations of existing capabilities can be generated, but only the ones that are valid and useful to a user from the business perspective or have a potential to be adopted by a user can be generated. Through excluding combinations that are not meaningful via the combined capability manifest, storage resources for storing generated combined capability definitions can be saved and usefulness of ultimately generated capabilities can be increased. In some embodiments, as shown in FIG. 6, in order to indicate which capabilities can be combined, the combined capability manifest 600 can include a list of capabilities to be combined. For example, the list can indicate capabilities to be combined through capability names defined in the corresponding capability definitions of the capabilities. In the example of the combined capability manifest 600 shown in FIG. 6, it is indicated the capabilities to be combined are the primary capabilities “search” 510 and “apigateway” 520 shown in FIG. 5. Also, a name for a combined capability to be generated based on a combination of the primary capabilities “search” 510 and “apigateway” 520 can be indicated in the combined capability manifest 600, which is shown in FIG. 6 as “solution-foo”.

As stated above, each combined capability definition in the hierarchy of capability definitions can be a combination of capability definitions and can be similar to the primary capability definition in format. Therefore, the new combined capability definition generated based on the existing capability definitions and the combined capability manifest can also define a name for a corresponding combined capability, which can be derived from the combined capability manifest 600 and in the example of FIG. 6 is “solution-foo”. The generated new combined capability definition can also define a set of deployable resources for the corresponding combined capability, which can be derived from the existing capability definitions based on the capabilities to be combined indicated in the combined capability manifest 600, and in the example of FIG. 6, the set of deployable resources defined in the combined capability definition for the combined capability “solution-foo” can include the set of deployable resources defined in the primary capability definition for the primary capability “search” 510 and the set of deployable resources defined in the primary capability definition for the primary capability “apigateway” 520.

In some embodiments, in the business owners' perspective, requirements may be set on versions of capabilities to be combined, so that the ultimately generated capabilities may have better performance or be more useful. Therefore, the combined capability manifest can define version constraints for one or more of the capabilities to be combined. In the example shown in FIG. 6, it is required that the primary capability “apigateway” 520 to be combined has to be in a version developed after v1.0.0-0, and that the primary capability “search” 510 to be combined has to be in a version developed after v1.2.0-0.

In some embodiments, similar to dependencies among deployable resources for a primary capability, at least some of the capabilities to be combined may also have dependencies, which means that provision of corresponding deployable resources defined in capability definitions of the capabilities in a capability level, from the capability transformer 220 to the workload provisioner 230, cannot be done in any random order, but to follow an order based on the dependencies. For example, assuming that a first capability is to be combined with a second capability, and the first capability has a dependency on the second capability, then deployable resources defined in the capability definition of the second capability has to be provided from the capability transformer 220 to the workload provisioner 230 before provision of deployable resources defined in the capability definition of the first capability, in order for the workload provisioner 230 to ultimately generate a combined capability which is a combination of the first capability and the second capability. Still taking the combined capability manifest 600 shown in FIG. 6 as an example, it can be seen that the capability “search” 510 has a dependency on the capability “apigateway” 520, deployable resources for the capability “apigateway” 520 has to be provided from the capability transformer 220 to the workload provisioner 230 before provision of deployable resources of the capability “search” 510. Therefore, the combined capability manifest 600 may also include information regarding dependencies among the capabilities to be combined.

Step 410 described above may be performed by taking the version constraint for the capabilities to be combined and/or dependencies among the capabilities to be combined into consideration. The dependencies among capabilities included in the combined capability manifest can be mapped to dependencies among corresponding deployable resources defined in existing capability definitions of the corresponding capabilities to be combined, and the generated new one or more new combined capability definitions can include the mapped dependencies among corresponding deployable resources and corresponding readiness information of related deployable resources.

In some embodiments, as shown in FIG. 6, the combined capability manifest 600 may also include one or more parameters, which can have one or more default values for customizing corresponding one or more parameters defined in capability definitions of the capabilities to be combined. In this case, the generated new capability definitions can also include the one or more default values.

The list of capabilities to be combined is shown as primary capabilities “search” 510 and “apigateway” 520, and the combined capability to be generated is shown as “solution-foo” in FIG. 6 for case of description and understanding, it should be appreciated that the number of capabilities to be combined in the list can be more than two, and the number of combined capabilities to be generated can be more than one. The combined capability manifest can include various combinations of two or more of the capabilities in the list.

With continued reference to FIG. 4, at step 420, a capability request directed to one or more capabilities can be received. The one or more capabilities can correspond to one or more capability definitions in the hierarchy of capability definitions. Step 420 can be performed by the capability transformer 220 in FIG. 2. The capability request may be sent from a user to customize or orchestrate one or more capabilities, which can be either primary or combined. The user may indicate the one or more capabilities through corresponding capability names defined in capability definitions. For example, capability names defined in capability definitions can be presented to the user, so that the user can choose one or more capabilities, either primary or combined, based on the presented capability names to form the capability request.

With reference now to FIG. 7, it is shown examples of two capability requests 710, 720 directed to a primary capability and a combined capability, respectively, according to an embodiment of the present disclosure. In the upper portion of FIG. 7, it is shown a capability request 710 with a name of “my-apigateway” directed to a primary capability with a name of “apigateway”, which has a corresponding primary capability definition as shown in FIG. 5. In the lower portion of FIG. 7, it is shown a capability request 720 with a name of “my-solution-foo-1” directed to a combined capability with a name of “solution-foo”, as can be learnt from FIG. 6, the combined capability “solution-foo” may correspond to a combination of primary capabilities “search” and “apigateway”, and has its corresponding combined capability definition. As further shown in FIG. 7, the capability request can include one or more values for instantiation of the one or more parameters defined in the hierarchy of capability definitions.

Referring back to FIG. 4, at step 430, the one or more capability definitions corresponding to the one or more capabilities indicated in the capability request can be determined from the hierarchy of capability definitions based on the capability request. Step 430 can be performed by the capability transformer 220 in FIG. 2. Determination of the one or more capability definitions from the hierarchy of capability definitions can be based on, for example, capability names indicated in the capability request. Taking the capability request 720 “my-solution-foo-1” in FIG. 7 directed to the combined capability “solution-foo” as an example, a combined capability definition with a capability name of “solution-foo” defined therein will be correspondingly determined. In order for ease of understanding and illumination, it is shown in FIG. 7 that the capability request 720 is directed to one primary capability or one combined capability, and therefore one primary capability definition or one combined capability definition will be determined accordingly. It can be understood that if the capability request 720 is directed to more than one capability, then more than one capability definition will be determined accordingly.

At step 440, deployable resources can be derived based on the determined one or more capability definitions. Step 440 can be performed by the capability transformer 220 in FIG. 2. As stated above, each capability definition in the hierarchy of capability definitions can define a set of deployable resources for a corresponding capability; therefore, once the one or more capability definitions have been determined, corresponding deployable resources defined in the capability definitions can be derived. In some embodiments, as stated above, deployable resources may have dependencies, and therefore for each capability definition in the hierarchy of capability definitions, step 440 can be performed in an order based on the readiness of one or more deployable resources in the set of deployable resources and dependencies between two or more deployable resources in the set of deployable resources, so that the derived deployable resources can be provided from the capability transformer 220 to the workload provisioner 230 in the order based on the readiness and the dependencies.

At step 450, the one or more capabilities indicated in the capability request can be generated based on the derived deployable resources. Step 450 can be performed by the workload provisioner 230 in FIG. 2. As stated above, the workload provisioner 230 herein may refer to any existing provisioning method or module in the cloud-native environment that supports cloud-native application deployment and using deployable resources to generate one or more corresponding capabilities. Therefore, by providing the derived deployable resources to the workload provisioner 230 from the capability transformer 220, the one or more capabilities indicated in the capability request can be generated.

In some embodiments, the generated one or more capabilities can form a cloud-native application, which can be delivered or provided to the user sending the capability request. In this way, capabilities from the same existing cloud native application or different existing cloud native applications can be combined based on business use case to build a new custom-oriented application for the user.

In view of the above, embodiments of the present disclosure can establish hierarchical capability definitions to manage a large number of capabilities from one or more existing cloud-native applications, provide one or more capabilities automatically based on a user's requirement and the large number of capabilities from one or more existing cloud-native applications, and require much less development effort.

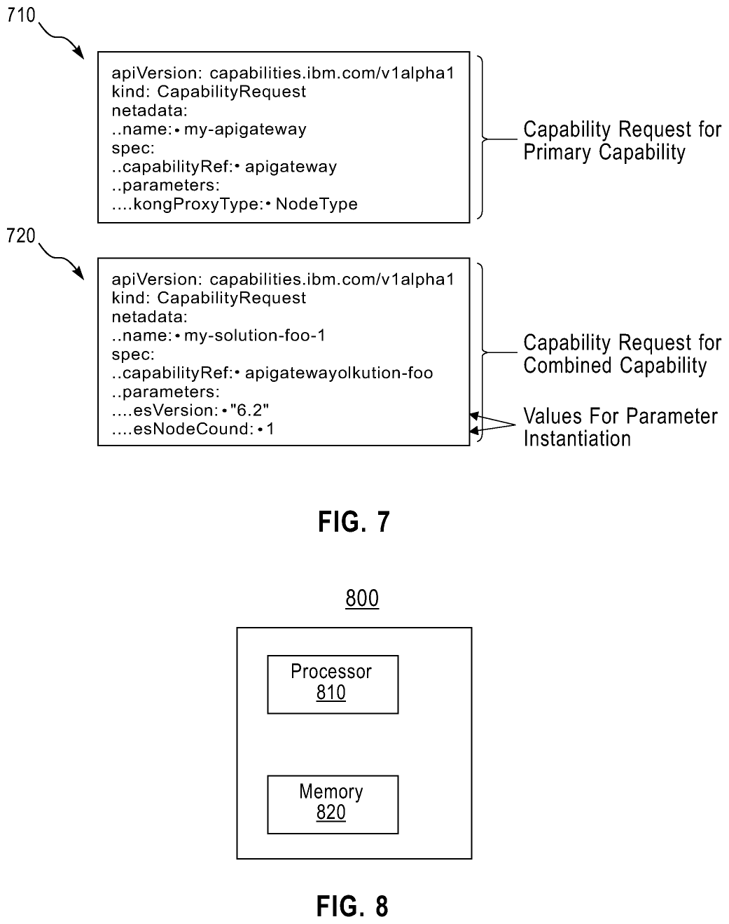

Referring now to FIG. 8, a system 800 for capability orchestration in a cloud-native environment is shown, according to an embodiment of the present disclosure. The system 800 can include one or more processors 810 and a memory 820 coupled to at least one of the processors 810. A set of computer program instructions are stored in the memory 820. When executed by at least one of the processors 810, the set of computer program instructions perform following series of actions for capability orchestration in a cloud-native environment. One or more new combined capability definitions can be generated based on existing capability definitions and a combined capability manifest to form a hierarchy of capability definitions, which include the one or more new combined capability definitions and the existing capability definitions. A capability request directed to one or more capabilities can be received. The one or more capabilities can correspond to one or more capability definitions in the hierarchy of capability definitions. The one or more capability definitions corresponding to the one or more capabilities can be determined from the hierarchy of capability definitions based on the capability request. Deployable resources can be derived based on the determined one or more capability definitions. The one or more capabilities can be generated based on the derived deployable resources.

In some embodiments, the combined capability manifest can include a list of capabilities to be combined, together with a version constraint for the capabilities to be combined and/or dependencies among the capabilities to be combined. The generation of the one or more new combined capability definitions can take the version constraint and/or the dependencies into consideration.

In some embodiments, each capability definition in the hierarchy of capability definitions can define a set of deployable resources for a corresponding capability, together with readiness of one or more deployable resources in the set of deployable resources and dependencies between two or more deployable resources in the set of deployable resources.

In some embodiments, the derivation of the deployable resources can be in an order based on the readiness and the dependencies.

In some embodiments, one or more capability definitions in the hierarchy of capability definitions can define one or more parameters to be customized, and the capability request can include one or more values for instantiation of the one or more parameters.

In some embodiments, the existing capability definitions include one or more primary capability definitions and/or one or more existing combined capability definitions.

In some embodiments, primary capabilities corresponding to the primary capability definitions can be from a same cloud-native application or different-cloud native applications.

In some embodiments, the capability definitions can be written in a markup language.

In some embodiments, the generated one or more capabilities can form a cloud-native application.

The descriptions above related to the process of method 400 can be applied to system 800, details are omitted herein for conciseness.

It should be noted that the processing of the computer-implemented method for capability orchestration in a cloud-native environment or the processing achieved by the system for capability orchestration in a cloud-native environment according to embodiments of this disclosure could be implemented in the computing environment of FIG. 1.

According to another embodiment of the present disclosure, a computer program product for capability orchestration in a cloud-native environment is disclosed. The computer program product can include a computer readable storage medium having program instructions embodied therewith, and the program instructions are executable by a processor. When executed, the program instructions can cause the processor to perform one or more of the above described procedures.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein. cm What is claimed is:

1. A computer-implemented method for capability orchestration in a cloud-native environment, comprising:
generating, by one or more processing units, one or more new combined capability definitions, based on existing capability definitions and a combined capability manifest, to form a hierarchy of capability definitions including the one or more new combined capability definitions and the existing capability definitions;
receiving, by the one or more processing units, a capability request directed to one or more capabilities, wherein the one or more capabilities correspond to one or more capability definitions in the hierarchy of capability definitions;
determining, by the one or more processing units, the one or more capability definitions corresponding to the one or more capabilities from the hierarchy of capability definitions based on the capability request;
deriving, by the one or more processing units, deployable resources based on the determined one or more capability definitions; and
generating, by the one or more processing units, the one or more capabilities based on the derived deployable resources.

2. The computer-implemented method of claim 1, wherein;
the combined capability manifest comprises a list of capabilities to be combined, together with a version constraint for one or more of the capabilities to be combined and dependencies among the capabilities to be combined; and
the generating the one or more new combined capability definitions takes one or more of the version constraint and the dependencies into consideration.

3. The computer-implemented method of claim 1, wherein:
each capability definition in the hierarchy of capability definitions defines a set of deployable resources for a corresponding capability, together with readiness of one or more deployable resources in the set of deployable resources and dependencies between two or more deployable resources in the set of deployable resources.

4. The computer-implemented method of claim 3, wherein the deriving the deployable resources is conducted in an order based on the readiness and the dependencies.

5. The computer-implemented method of claim 1, wherein:
one or more capability definitions in the hierarchy of capability definitions define one or more parameters to be customized; and
the capability request comprises one or more values for instantiation of the one or more parameters.

6. The computer-implemented method of claim 1, wherein the existing capability definitions comprises one or more primary capability definitions and one or more existing combined capability definitions.

7. The computer-implemented method of claim 6, wherein primary capabilities corresponding to the primary capability definitions are from at least one of a same cloud-native application and different cloud-native applications.

8. The computer-implemented method of claim 1, wherein the capability definitions are written in a markup language.

9. The computer-implemented method of claim 1, wherein the generated one or more capabilities form a cloud-native application.

10. A system for capability orchestration in a cloud-native environment, comprising:
one or more processors;
a memory coupled to at least one of the one or more processors;
a set of computer program instructions stored in the memory, which, when executed by at least one of the one or more processors, perform actions of:
generating one or more new combined capability definitions, based on existing capability definitions and a combined capability manifest, to form a hierarchy of capability definitions including the one or more new combined capability definitions and the existing capability definitions;
receiving a capability request directed to one or more capabilities, wherein the one or more capabilities correspond to one or more capability definitions in the hierarchy of capability definitions;
determining the one or more capability definitions corresponding to the one or more capabilities from the hierarchy of capability definitions based on the capability request;
deriving deployable resources based on the determined one or more capability definitions; and
generating the one or more capabilities based on the derived deployable resources.

11. The system of claim 10, wherein:
the combined capability manifest comprises a list of capabilities to be combined, together with a version constraint for one or more of the capabilities to be combined and dependencies among the capabilities to be combined; and
the generating the one or more new combined capability definitions takes one or more of the version constraint and the dependencies into consideration.

12. The system of claim 10, wherein:
each capability definition in the hierarchy of capability definitions defines a set of deployable resources for a corresponding capability, together with readiness of one or more deployable resources in the set of deployable resources and dependencies between two or more deployable resources in the set of deployable resources.

13. The system of claim 12, wherein the deriving the deployable resources is conducted in an order based on the readiness and the dependencies.

14. The system of claim 10, wherein:
one or more capability definitions in the hierarchy of capability definitions define one or more parameters to be customized; and
the capability request comprises one or more values for instantiation of the one or more parameters.

15. The system of claim 10, wherein the existing capability definitions comprises one or more primary capability definitions and one or more existing combined capability definitions.

16. The system of claim 15, wherein primary capabilities corresponding to the primary capability definitions are from at least one of a same cloud native application or different cloud-native applications.

17. The system of claim 10, wherein the capability definitions are written in a markup language.

18. The system of claim 10, wherein the generated one or more capabilities form a cloud-native application.

19. A computer program product for capability orchestration in a cloud-native environment, the computer program product comprising a computer readable storage medium having program instructions embodied therewith, the program instructions executable by a processor to cause the processor to:
generate one or more new combined capability definitions, based on existing capability definitions and a combined capability manifest, to form a hierarchy of capability definitions including the one or more new combined capability definitions and the existing capability definitions;
receive a capability request directed to one or more capabilities, wherein the one or more capabilities correspond to one or more capability definitions in the hierarchy of capability definitions;
determine the one or more capability definitions corresponding to the one or more capabilities from the hierarchy of capability definitions based on the capability request;
derive deployable resources based on the determined one or more capability definitions; and
generate the one or more capabilities based on the derived deployable resources.

20. The computer program product of claim 19, wherein:
the combined capability manifest comprises a list of capabilities to be combined, together with a version constraint for on woe more of the capabilities to be combined and dependencies among the capabilities to be combined; and
the generating the one or more new combined capability definitions takes one or more of the version constraint and the dependencies into consideration.
